(19) United States
(12) Patent Application Publication
(10) Pub. No.: US 2004/0243670 A1
(43) Pub. Date: Dec. 2, 2004

(54) Method for the optimized use of sctp(stream control transmission protocol) in mpls(multi protocol label switching) networks

(76) Inventors: Jochen Grimminger, Munchen (DE); Michael Tuxen, Oldenburg (DE)

Correspondence Address: MORRISON & FOERSTER LLP, 1650 TYSONS BOULEVARD, SUITE 300, MCLEAN, VA, 22102, US

(21) Appl. No.: 10/483,339

(22) PCT Filed: Jul. 1, 2002
(86) PCT No.: PCT/DE02/02381

(30) Foreign Application Priority Data
Jul. 10, 2001 (DE) 10133473.7

(51) Int. Cl. G06F 15/16

(52) U.S. Cl. 709/203

(57) ABSTRACT

The invention relates to a method for transmitting information between two entities via a network. Said method comprises a first protocol that uses network paths, which are identified by labels and whose target entity and source entity are un-equivocally defined, for transmitting information between the entities and comprises a second transport protocol, which is built on the first protocol. According to the invention, the transport protocol guarantees the receipt of information by means of a confirmation. The method also comprises a first initialising step, in which 1 to n labels of network paths, which permit an information exchange between the entities, are exchanged via a first network path and a second information exchange step, in which the information is exchanged via the 1 to n network paths. The first protocol is preferably MPLS, each FEC standing for a unique target and source entity. The second protocol is preferably SCTP, the IP addresses being replaced by the labels from the network paths.

Method for the optimized use of SCTP (Stream Control Transmission Protocol) in MPLS (Multi Protocol Label Switching) networks

SCTP [RFC 2960] is a transport protocol which offers high network redundancy, i.e. it is ensured that all transmitted data arrive in the correct order. In this process, not only one possible transport path is used as, e.g. in TCP [RFC 0793] (implemented by IP [RFC 0791]) but a number of these. This is necessary in applications which must achieve a very high degree of availability such as signaling in PSTN networks. The network layer used is IP. SCTP supports IP by suitable (generic) parameters in the messages which are exchanged between two partners when the connection is being set up. Today in “IP” core networks a s used in wireless communication with, e.g. UMTS, pure IP is more and more frequently no longer used. Rather, direct LSPs (Label Switched Path) between individual network elements are set up with the aid of MPLS (Multi Protocol Label Switching [RFC 3031]), also using traffic engineering. Known methods have been disclosed in the documents [RFC 2960] and [RFC 3031]. Here it concerns primarily manufacturer-specific methods.

It is the object of the present invention to use SCTP in an optimized manner in MPLS networks.

It is achieved by the features of the independent claims, particularly by a method for transmitting information via a network between two entities, with a first protocol which uses, for the transmission of information between the entities, network path s which are identified by labels and the destination entity and source entity of which is unambiguously determined. This first protocol is only used for routing the information to the destination entity. It does not handle the task of checking whether the information has actually arrived. This requires a second transport protocol. The second transport protocol, which builds on the first protocol, confirms the reception of an information item by means of confirmation information sent back to the source entity. The method of the present invention is intended to provide not only one path for transmitting information but a number of paths. These must be communicated during the setting-up of the communication.

In a first init step, 1 to n labels of other network paths are exchanged via a first network path. Each of these network paths allows an unambiguous exchange of information between the entities. After the network paths have been exchanged, via which the communication and the information exchange is to take place, the information to be transmitted is communicated via the 1 to n network paths. Depending on the load situation or response behavior on the individual network paths, the information to be transmitted can be distributed to less loaded network paths.

To avoid collision and to increase the throughput, the network paths are only used for unidirectional information exchange. Bidirectional use is also conceivable but does not correspond to the specifications of SCTP.

In a preferred embodiment, the first protocol is MPLS. The detailed structure of the protocol can be found in [RFC 3031]. Furthermore, the principles of this protocol are described below. In principle, network protocols are mapped by individual layers. The MPLS protocol is in this case arranged in layer 2. In this protocol, an IP protocol is normally provided in layer 3 in order to ensure the uniqueness of the receiver entity and the transmitter entity of the information packet. In this layer 3, TCP or, alternatively, SCTP is used as transport protocol in layer 4. These two protocols ensure that the information packet has actually arrived by sending a new packet if the confirmation of reception does not arrive at a transmitter within a prescribed time window. Due to the present invention, layer 3, and thus its overhead, can be omitted.

In an MPLS network, so-called “Forwarding Equivalence Classes” (FECs) are used. These classes are used for mapping particular IP addresses to a label. If, in contrast, there is a bijective relation between the IP address and the equivalence class, the label can be used for handling the task of the third layer. This means that only one label is used for the transmitter and receiving IP address. As a result, each FEC stands for an unambiguous destination entity and an unambiguous source entity. Normally, in SCTP, a number of IP addresses are exchanged which are administered as destination and source addresses, respectively, and via which information is exchanged. An entity thus has a number of IP addresses. It is called a multi-homed entity. Details about the SCTP are found in RFC 2960 or further below. As rule, an entity is a server or a known computer. However, it is also conceivable that there are other network components such as, e.g. routers.

The transport protocol of the method according to the invention is SCTP, where the IP addresses are replaced by the labels of the network paths. In a further embodiment, special path ID labels are introduced which are arranged in the stack of the information packets and allow an unambiguous location of the information to the individual source and destination entities. As a result, the selected path doe s not need to be unambiguous in contrast to the abovementioned alternative. Using a path ID label ensures that IP addresses can be omitted because the receiver can recognize from a path IP label where the in formation comes from. The transport protocol has the basic task of ensuring that the information arrives and its order is maintained. For this purpose, the known methods of the SCTP which are also known from TCP are used. The individual packets which contain separated information items are numbered. By means of this numbering, the order of assembly can be examined. The TSN (Transmission Sequence Number) is allocated to each information packet. Each response of the receiver or destination entities contains the TSN which has been previously communicated by the transmitter or source entity. As a result, it is possible to determine whether packets have actually arrived or are lost. If a response has not arrived within the RTT (Round-Trip Time), the packet is retransmitted. The RTO (Retransmission Time-Out) specifies the time interval at the end of which the packet is retransmitted.

Before the network paths can be used for exchanging information, they must be set up. For this purpose, known methods relating to traffic engineering are used which preferably operate with IP addresses, the routers or the switches being configured in such a manner that the destination and source entities are unambiguous for a path. Possible procedures are described in the documents specified in the introduction part of the description, in particular RFC3031.

In a further embodiment, label stacking is used during the transmission. For each data packet, a stack is allocated in which labels are administered. Each label stands for an equivalence class as has already been described above. If a data packet with a label arrives at a router, the topmost label is taken off the stack and replaced by a new label which corresponds to this equivalence class in the current router. The initial label and the end label can thus be used for setting out the path of the packet with its information. During the transmission of information, SCTP selects different network paths in dependence on the throughput or the response time. This ensures a constant high throughput. A further component of the invention is a device for exchanging information via a network which has means for performing the method according to the invention. These are preferably terminals in the form of computers which have a network interface. There are also routers which are located at the beginning of a path. They must be capable of allocating the labels to the corresponding terminals.

A possible embodiment of the present invention is shown in the figures, in which:

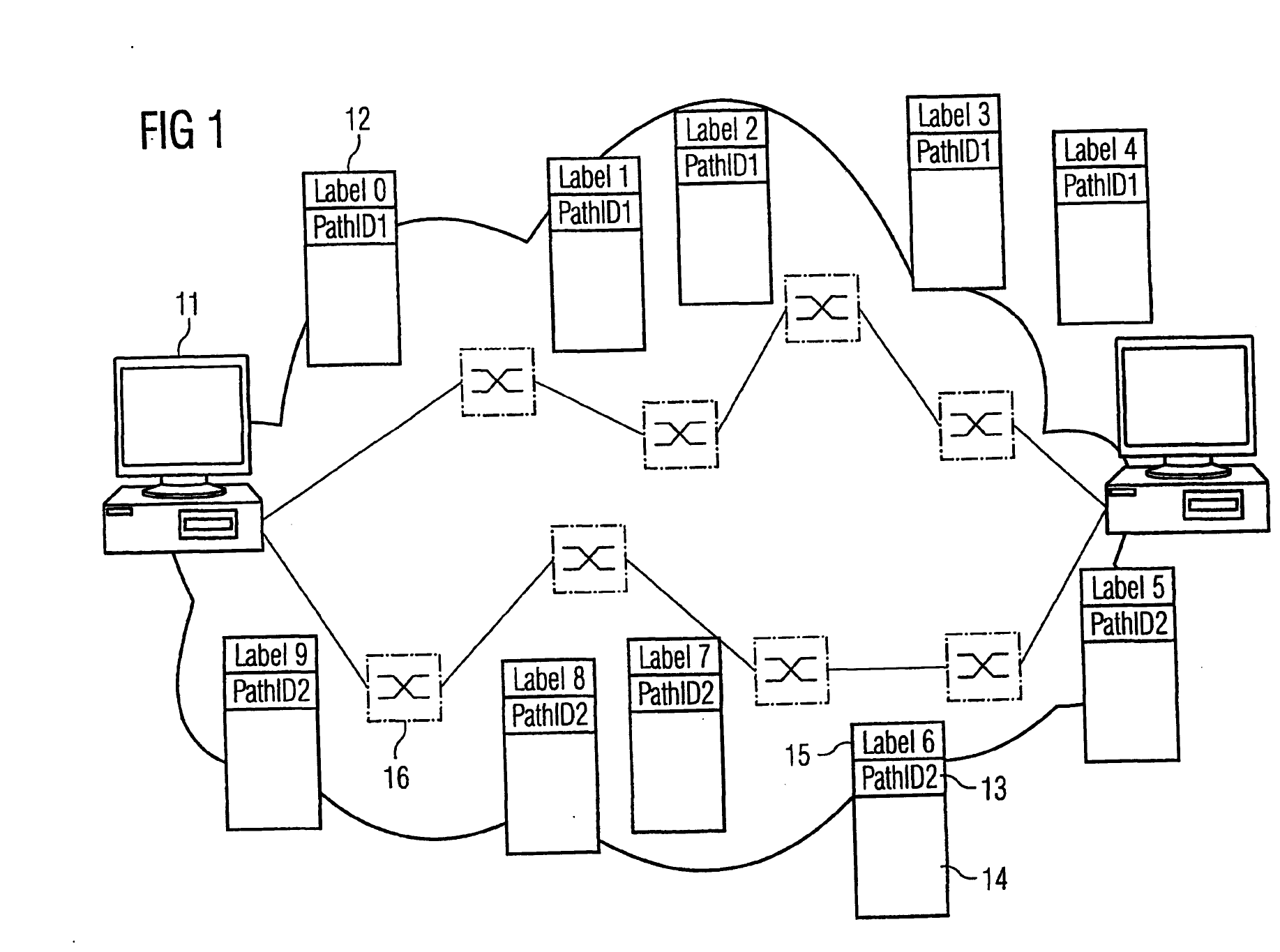

FIG. 1 shows a network with routers which use label stacking, each router exchanging the label of the preceding router and replacing it with its own label, a path ID label which is arranged in the stack being additionally used for ensuring uniqueness;

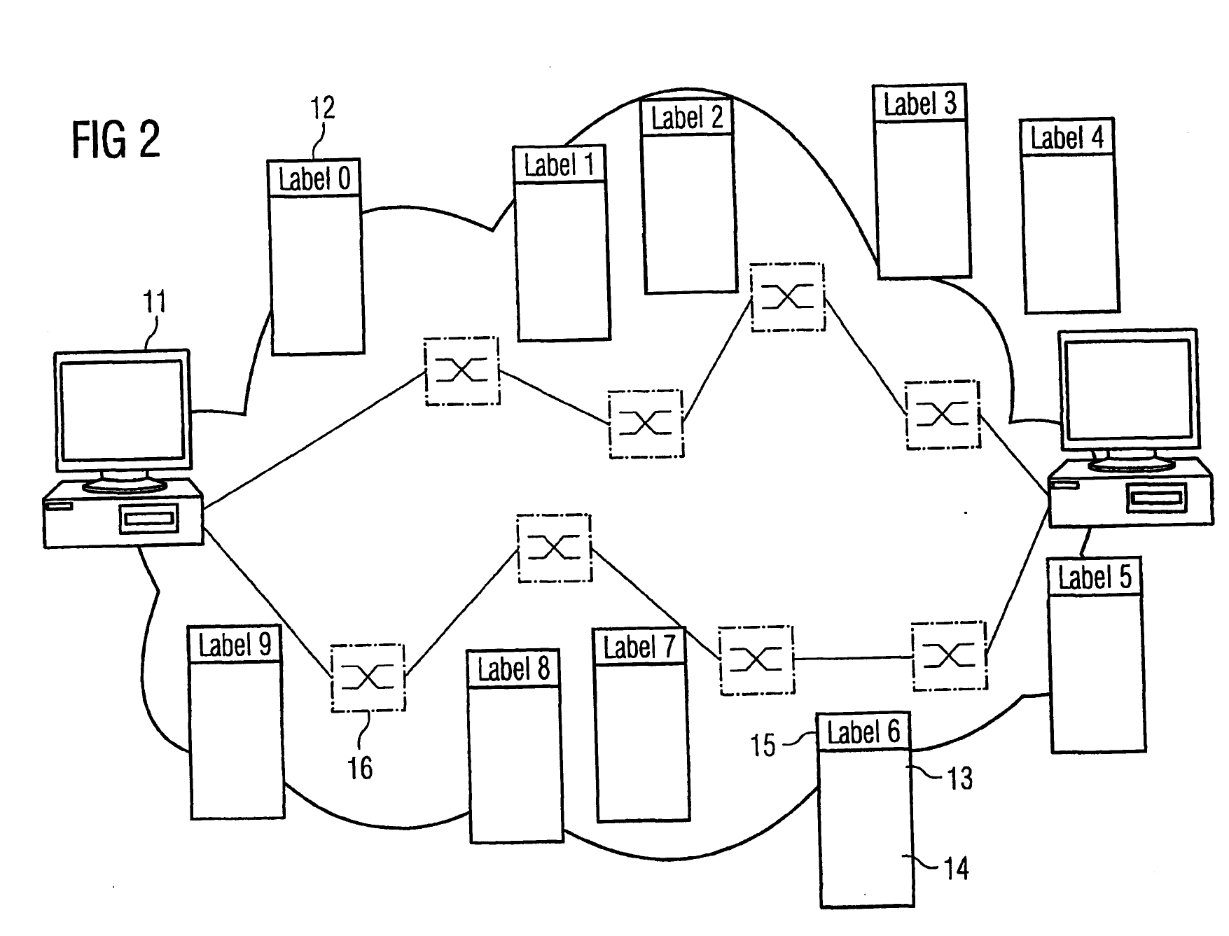

FIG. 2 shows a network with routers which use label stacking, each router exchanging the label of the preceding router and replacing it with its own label, the labels describing an unambiguous path;

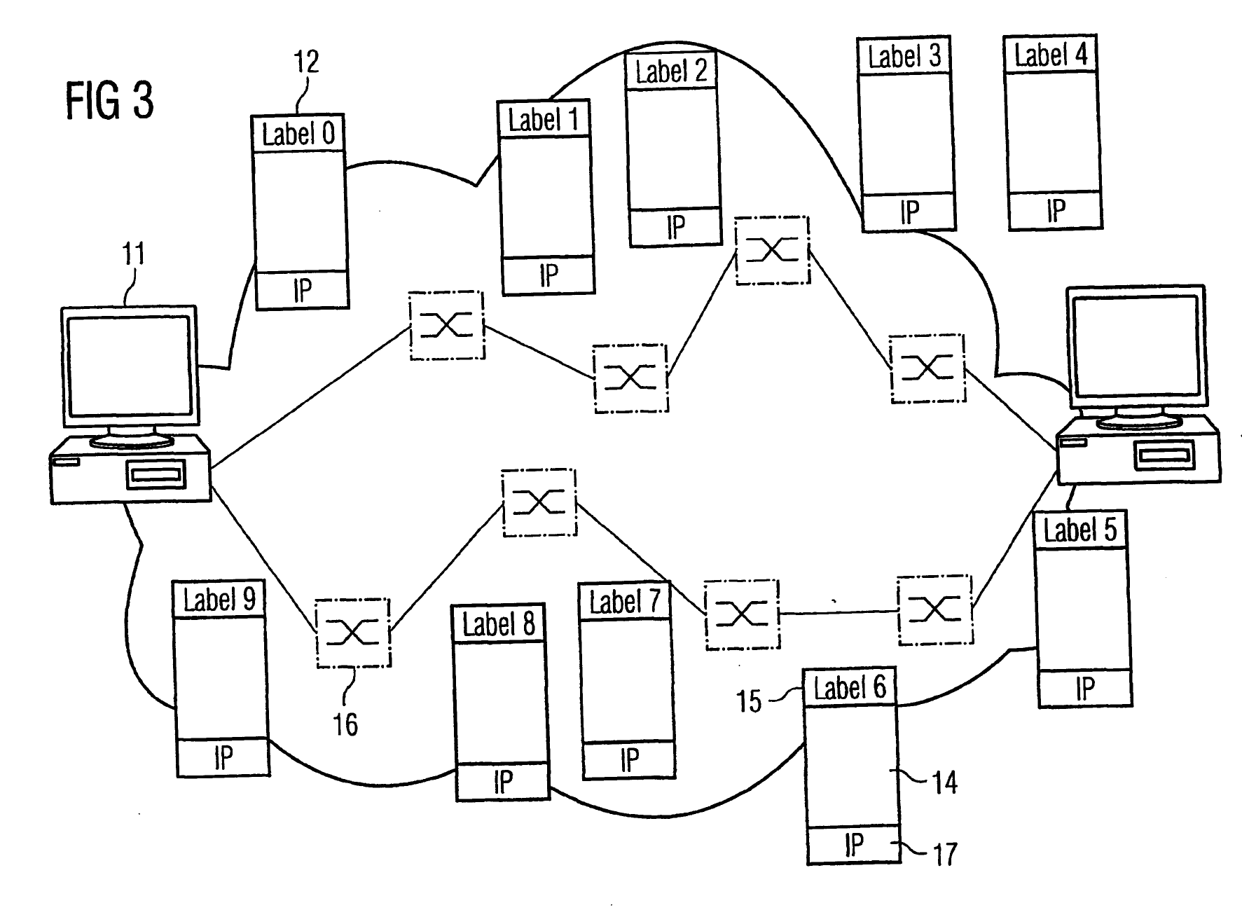

FIG. 3 shows a network which reproduces the prior art, the IP address being arranged in the data packet.

FIG. 1 shows an MPLS network with two entities 11. These are connected to one another by means of two paths. The data packets 12 are routed via routers 16 through the network in order to arrive at the corresponding destination entity 11. The paths are identified by the path ID label 13. The first path has the path ID label “pathID1”. The second path is identified by the path ID label “pathID2”. Each data packet 12 has a stack in which the labels are located. The topmost label 15 determines the FEC. During the first transmission, the label having the number 0 is allocated to the data packet. The first router exchanges this label for label 1. The last router on this path exchanges the label for the label having the number 4. In the response, the second path is used. During the process, the stack of the data packets is also provided with corresponding labels which are replaced by each router. The label determining the path is never exchanged so that the receiver can unambiguously determine the source of the packet.

FIG. 2 shows an embodiment without the path ID label. The prerequisite is, however, that each label is allocated to an unambiguous path. A path is unambiguous whenever source and destination entity are unambiguous. FIG. 3 shows the prior art in which the IP address is arranged in the information 14 to be transported. If, as usual, the labels should not be unambiguous but only determine equivalence classes, it may be necessary for the IP address in the information to be transported to be analyzed for a routing decision. This analysis can be very complex and needs additional logic in the router.

In the text which follows, the individual protocols and their modification will be discussed in detail. In MPLS networks, a packet travels from one router to the next. Each router makes an independent decision with regard to the forwarding. That is to say each router analyses the header of the packet and each router runs a program with the router algorithm. Each router selects a new route in dependence of the result of the router algorithm. The next route is thus selected in two steps. In the first step, the complete sets of possible packets are partitioned into a set of equivalent classes (FEC). In the second step, each FEC is mapped to a route. With respect to the decision of the forwarding, no distinction is made between the packets which belong to the same FEC. Different packets belonging to the sa me FEC cannot be distinguished. Different packets are considered to be the packets which have a different destination or source address. However, in order to be able to use MPLS for the present invention, a path, and thus the equivalence class, must be unambiguous. This means that an equivalence class stands for an unambiguous source and destination entity or for its addresses, respectively. In an MPLS network, the allocation to an FEC takes place only once, namely when the packet enters the network. The FEC to which a packet is allocated is coded as a short value which is called a label. If a packet is sent to the next route, the label is also sent. In the subsequent routers, the further contents of the packet are not analyzed in any way. Only the label is checked. The label is used as an index for a table in which the next route and the next label can be found. The old label is replaced with the new label and the packet is forwarded into the next route. In an MPLS network, the forwarding is only controlled by the labels. This has a number of advantages. Thus, the routers only need to have low capabilities. They only need to be capable of analyzing the label and checking in a table the route to which this label is allocated in order to replace the old label with a new label. Furthermore, these simple tasks make it possible to achieve a high throughput. Further advantages can be found in RFC 3031.

In the text which follows, some principles will be defined. A label is a short, locally significant designator which has a fixed length in order to identify an FEC. The label is used for representing an FEC to which the packet is allocated. In the basic application of the FEC, it is allocated to the network layer on the basis of the destination addresses. However, the original application of the FEC is not coding of the network address. It is precisely at this point that the present invention makes a distinction. Due to the unambiguous allocation of the label to an unambiguous path, this is coding of a network address.

To ensure that the routers allocate the packets to the same equivalence classes, the routers must regularly exchange information from which can be seen which packets are allocated to a label. Furthermore, it is important that different routers do not use the same labels in as much as this prevents an unambiguous identification of the preceding router. It must also be pointed out that upstreams and downstreams are dealt with differently. Thus, they do not necessarily have the same labels. In the MPLS architecture, the decision of binding a particular label to a particular equivalence class is made by the router which is downstream with respect to this binding. The downstream router then informs the upstream router about this binding. This information can be transmitted, e.g. as piggyback information on other packets.

In a further embodiment, MPLS supports a hierarchy, the processing of the packets provided with labels being completely independent of the level of the hierarchy. A packet which does not have a label can be considered as a packet, the stack of which is empty. The use of the stack becomes clear when talking about tunneling of the packets. Such tunneling can be found in the document RFC 3031. Packets are tunneled whenever they are conducted through a network path which is located between two routers, this network path, in turn comprising a number of routers. If, e.g., an explicit path was predetermined which comprises routers R1 to R4 and if between router R1 and R2 a path is located which comprises routers R1.1, R1.2, R1.3, a further label is pushed onto the stack by router R1. Routers R1.1, R1.2, R1.3 then operate on this new second element. As soon as a packet arrives at router R2, the top-most element is popped off the stack. It becomes problematic if there is no label on the stack. In the normal MPLS architecture, the network address (normally the IP address) is analyzed in order to determine an equivalence class. When the present invention is used, this situation must not occur. MPLS offers two types of route selection. One type of route selection already specifies the route at the starting point. The individual routers which must be passed are determined. This is explicit routing. In the case of hop-by-hop routing, the routers are not explicitly specified so that each router can specify the subsequent router from its tables. The present invention can be operated with both options of route selection.

SCTP is a reliable transport protocol which is originally based on packet networks such as IP. In the present embodiment, however, IP, in particular, is not utilized. This makes it possible to save layer 3 of the network arrangement.

SCTP has the following advantages:

1. Confirmed error-free transmission of user data without options

2. Data fragmentation in the context of MTU (maximum transmission unit. In a packet-based network (e.g. TCP/IP), an MTU is the size of the packet which can just be transmitted. TCP/IP uses the MTU for determining the size of a packet during each transmission. If too large a packet occurs—one which can no longer be transferred by the router—it is sent back to the corresponding computer.)

3. Data transmission via a number of paths, these data having sequence numbers in order to prevent a transmission of information which does not correspond to the original sequence.

4. High degree of error tolerance by supporting multi-homed entities at both ends of the association.

In the original embodiment, SCTP was considered as a layer between the user application and the connectionless packet network such as IP. In the present form, however, the IP network becomes superfluous. The advantages of this have already been described above. SCTP is by its nature a connection-oriented association between two entities but is designed more broadly than TCP with respect to its concept.

An association is initiated by an inquiry by an SCTP user. During the initialization of the association, a cookie mechanism similar to that described in RFC 2522 is used for providing protection against security attacks. Furthermore, the connection is terminated if this is wanted by the user. Thus, a half open state as known from TCP is impossible. Once the connection has been closed, no new data are accepted.

The number of data streams in SCTP is specified at the time of initialization of the connection. The number is specified by the two entities. Information exchanged via these streams has corresponding numbers.

Internally, the SCTP allocates to each information item or each information packet an unambiguous stream sequence number. Using different stream ensures that the information is transmitted even if one of the streams is blocked. In the present invention, the streams correspond to the individual network paths which are identified by labels. A TSN (transmission sequence number) is allocated to each data packet. The TSN is independent of any stream sequence number. The receiver or destination entity confirms the reception of a packet by sending back the TSN. This ensures that all packets arrive. If a packet has been lost, it is retransmitted. Furthermore, a timer specifies whether the packet is to be retransmitted. If the response times have not been met, the timer is incremented and the packet is retransmitted. The timer is incremented up to an upper limit until a response to the packet is received. The consistency of the packet is checked by a checking field.

In the text which follows, the setting up of a connection is described and it is noted how the known SCTP differs from the modified protocol according to the invention. Before a first data transmission can take place between two SCTP entities (A and Z), a complete initialization process must be performed in which an SCTP association is created.

After an association has been set up, unidirectional data streams can be transmitted via the paths. The initialization process consists of the following steps. Entity A first sends an initialization packet to entity Z. This initialization packet contains a checking tag in a corresponding field (tag_A). The tag is a corresponding random number. Once this initialization packet has been sent, a timer is started. Entity A is placed into a cookie waiting state. Entity Z must immediately respond to this with an initialization response packet. Instead of the IP addresses, labels or path IP labels are now exchanged. Path ID labels are exchanged whenever the path described by the label is not unambiguous. A path is not unambiguous whenever the destination entity cannot be unambiguously determined at the last router. This is the case whenever the equivalence class of the last label is not unambiguous, that is to say bijective. Entity Z must then send the checking field tag_A and tag_Z and a cookie as confirmation. After this confirmation has been received, the timer of entity A is stopped. The state also changes. A cookie response is then sent to entity Z which informs it that the cookie has been received. Following this, a timer is again started by entity A. This timer is stopped after entity Z has confirmed the reception of the cookie response. A termination of the connection must always be reported to the corresponding entity. Once the connection or association has been set up in this manner, the data are exchanged by the paths. To monitor the connections, test information is regularly transmitted. This makes it possible to determine the state of the connection.

Further details can be found in RFC 2960.

1. A method for transmitting information via a network between two entities, comprising a first protocol which is essentially MPLS and which, for the transmission of information between the entities, uses network paths which are identified by labels which are in each case used for representing an FEC (forward equivalence class) in MPLS, a destination entity and a source entity of the network paths being unambiguously determined with a label and the label being unambiguously allocated to a network path,
with a second transport protocol which builds on the first protocol, the transport protocol ensuring the reception of information by means of a confirmation information item,
with a first init step in which 1 to n labels are exchanged by network paths which allow an exchange of information between the entities, via a first network path, with a second step of information exchange in which the information is exchanged via the 1 to n network paths.

2. The method as claimed in claim 1, characterized in that the second transport protocol is an SCTP, the IP addresses being replaced by the labels of the network paths.

3. The method for transmitting information via a network between two entities,
comprising a first protocol which is essentially MPLS and which, for the transmission of information between the entities, uses network paths which are identified by labels which are in each case used for representing an FEC (forward equivalence class) in MPLS, a destination entity and a source entity being unambiguously determined by a further path ID label and the path ID label being unambiguously allocated to a network path,
with a second transport protocol which builds on the first protocol, the transport protocol ensuring the reception of information by means of a confirmation information item,
with a first init step in which 1 to n labels of network paths allowing an exchange of information between the entities are exchanged via a first network path, the path ID label never being exchanged,
with a second step of information exchange in which the information is exchanged via the 1 to n network paths.

4. The method as claimed in claim 3, characterized in that the second transport protocol is an SCTP, the IP addresses being replaced by the path ID labels of the network paths.

5. The method as claimed in claim 1, characterized in that to ensure the transmission of information, the known methods of SCTP are used such as numbering of the part-information, TSN, RTO and/or RTT.

6. The method as claimed in claim 1, characterized in that before the communication between entities is set up, the network paths are initialized, using known methods for traffic engineering which preferably operate with IP addresses, the routers/switches being configured in such a manner that the destination and source entities are unambiguously determined for a path.

7. The method as claimed in claim 1, characterized in that network different paths are used during the transmission of information, depending on the throughput and/or the response time.

8. The method as claimed in claim 1, characterized in that label stacking is used in the MPLS protocol.

9. The method as claimed in claim 1, characterized in that the network paths are only used for unidirectional information exchange.

10. A device for exchanging information via a network, characterized in that the device has means for implementing a method as claimed in claim 1.
